(19) United States
(12) Patent Application Publication
(10) Pub. No.: US 2018/0204484 A1
(43) Pub. Date: Jul. 19, 2018

(54) AUTOMATIC ALTERNATIVE CONTENT SEARCH APPARATUS FOR VISUALLY IMPAIRED PERSON

(71) Applicant: Insik SEO, Daejeon (KR)

(72) Inventor: Insik SEO, Daejeon (KR)

(21) Appl. No.: 15/740,805

(22) PCT Filed: Aug. 5, 2016
(86) PCT No.: PCT/KR2016/008633

§ 371 Date: Dec. 29, 2017

(30) Foreign Application Priority Data
Aug. 6, 2015 (KR) 10-2015-0111301
Aug. 6, 2015 (KR) 10-2015-0111303

(51) Int. Cl. G09B 21/00; A47B 23/06; F16M 11/38; G06K 9/00; G06K 9/20; G10L 13/04

(52) U.S. Cl. CPC G09B 21/006; A47B 23/06; F16M 11/38; G06K 2209/501; G06K 9/209; G10L 13/043; G06K 2209/01; G06K 9/00463

(57) ABSTRACT

The present invention relates generally to an automatic alternative content search apparatus for a visually impaired person. More particularly, the present invention relates to an automatic alternative content search apparatus for a visually impaired person, the apparatus recognizing a book or a document, which is placed on a main body, by a camera so as to output the recognized book or document content as a voice, and recognizing characters and images of a textbook cover so as to automatically search for and provide textbook content or alternative content, thereby solving an information accessing problem of a visually impaired person.

### TECHNICAL FIELD

The present invention relates generally to an automatic alternative content search apparatus for a visually impaired person. More particularly, the present invention relates to an automatic alternative content search apparatus for a visually impaired person, the apparatus recognizing a book or a document, which is placed on a main body, by a camera so as to output the recognized book or document content as a voice, and recognizing characters and images of a textbook cover so as to automatically search for and provide textbook content or alternative content, thereby solving an information accessing problem of a visually impaired person.

### BACKGROUND

In general, a reading desk provided in a library or the like is simply a desk-like type, so that users are allowed to borrow a book and then sit on the reading desk to read the book. However, there was no consideration for especially those who are visually impaired or have poor vision, and thus they are forced to read books using a magnifying glass. In addition, in the case of a visually impaired person, there is no way to read books except Braille books.

In an effort to solve such a conventional problem, there was proposed a method in which a user places a reading camera above a book, places a desired portion to be read correspondingly to a hole of the reading camera, and adjusts the focus and height using a focus and height adjusting ring of a main body, thereby reading the book on a monitor connected with the reading camera via a cable.

However, this method is inconvenient to operate and a user himself or herself must operate the camera directly and find a desired portion that will be entered into the camera and read, which is not helpful for those who are visually impaired.

In addition, for those who are visually impaired, an optical character reader that captures a document with a camera and converts images of the captured document into a digitized text which then can be provided as voice has been developed. However, the conventional optical character reader has a disadvantage that it is difficult to provide various book contents desired by a user.

Further, the conventional reading desk has a disadvantage that it is difficult to fix books or documents of various sizes because a fixing device for fixing the books or documents is configured to be moved laterally.

In addition, in the case of books, since shapes vary, conventional fixing device may not to stably fix the books having various shapes. As a result, the pages of a book may be turned arbitrarily or the user's hands or other objects may interfere, leading to a situation in which reading is impossible, thereby causing user inconvenience. Furthermore, character recognition may not be efficiently performed, leading to loss of time and cost.

### DOCUMENTS OF RELATED ART

(Patent Document 1) Korean Patent Application Publication No. 10-2006-0007496

(Patent Document 2) Korean Patent No. 10-1162068

(Patent Document 3) Korean Patent Utility Model No. 20-0460984

### DISCLOSURE

### Technical Problem

Accordingly, the present invention has been made keeping in mind the above problems occurring in the prior art, and an object of the present invention is to provide an automatic alternative content search apparatus for a visually impaired person, the apparatus being capable of automatically searching for textbook content and alternative content by recognizing characters of a textbook cover and thus enabling access to various alternative educational content.

Another object of the present invention is to provide an automatic alternative content search apparatus for a visually impaired person, in which an images of books and documents are captured by a camera, the captured images are converted into characters by a recognition processing unit, and the converted characters are reproduced as speech by a voice output unit, thereby allowing a visually impaired person to easily access information.

A further object of the present invention is to provide an automatic alternative content search apparatus for a visually impaired person, in which a fixing device for fixing books or documents is configured to be automatically adjusted in position and thus provides user convenience, and to stably fix books and documents placed on a reading desk.

Still another object of the present invention is to provide an automatic alternative content search apparatus for a visually impaired person, in which the fixing device fixing a book or a document is configured to be vertically adjusted in position so as to stably fix book surfaces having various shapes, thereby preventing a situation where character reading is impossible when the pages of a book are turned arbitrarily or the user's hands or other objects interfere and thus enabling an optimized environment for character reading.

The objects of the present invention are not limited to the above-mentioned objects, and other objects that have not been stated will be apparent to a person skilled in the art from the following description.

### Technical Solution

In order to accomplish the above object, the present invention provides an automatic alternative content search apparatus for a visually impaired person, the apparatus including: a main body 2 on which a book or a document is placed; a support part 3 vertically provided at a center of a first end of the main body 2 and configured such that a first support portion 4 and a second support portion 5 are folded together; a head part 6 provided at an end of the support part 3 and provided with a camera and a light lamp; a recognition processing unit including an image recognition unit recognizing an image captured by the camera and a character recognition unit recognizing the image read by the image recognition unit as characters; a voice output unit outputting the characters recognized by the recognition processing unit as voice; and lower and upper fixing devices 10 and 20 fixing the book or the document placed on the main body 2.

Further, the lower fixing device 10 may include: a lower fixing member 11 fixing the book or the document; a cylinder 12 provided at a lower end of the lower fixing member 11; a cylinder fixing portion 13 fixing the cylinder 12; a fixing frame 14 provided at each of opposite sides of the cylinder fixing portion 13 and surrounding the cylinder fixing portion 13;

a moving portion 15 provided at a lower end of the fixing frame 14 and provided with bearings 16 mounted thereon; and a limit switch detecting unit 18 provided at an end of the moving portion 15, and the upper fixing device 20 may include: an upper fixing member 21 including a first fixing portion 22 and a second fixing portion 23; a cylindrical portion 24 provided at a lower end of the upper fixing member 21; and a support portion 25 provided at an outside of the cylindrical portion.

### Advantageous Effects

According to the automatic alternative content search apparatus for a visually impaired person according to the present invention, by adopting a foldable stand type integrated camera considering the characteristics of the visually impaired person, the problem of loss and failure can be solved compared with a separated type camera.

Further, the alternative content is automatically searched by recognizing characters of the textbook cover and the searched content is provided, whereby access to various alternative educational content is possible.

Furthermore, the purpose of character recognition of a document such as a bill or a business card is determined and data corresponding thereto is provided, whereby various data required by a user can be easily obtained.

In addition, the automatic search apparatus can be adjusted in position according to the size of a book or a document, and an up-and-down fixing method other than a right-and-left fixing method is adopted whereby books having various sizes can be stably fixed.

Moreover, book surfaces having various shapes are stably fixed, thereby preventing a situation where character reading is impossible when the pages of a book are turned arbitrarily or the hands or other objects interfere and thus enabling an optimized environment for character reading. Consequently, character recognition performance of the apparatus can be improved.

### BRIEF DESCRIPTION OF THE DRAWINGS

FIG. 1 is a perspective view showing an automatic alternative content search apparatus for a visually impaired person according to an embodiment of the present invention.

FIG. 2 is a perspective view showing a state where a support part and a head part of the automatic alternative content search apparatus for the visually impaired person according to the embodiment of the present invention are folded.

FIG. 3 is a perspective view showing a state where a book is fixed to the automatic alternative content search apparatus for the visually impaired person according to the embodiment of the present invention.

FIG. 4 is a flowchart showing steps of receiving textbook content using the automatic alternative content search apparatus for the visually impaired person according to the embodiment of the present invention.

FIG. 5 is a flowchart showing steps of outputting recognized characters as voice by the automatic alternative content search apparatus for the visually impaired person according to the embodiment of the present invention.

FIG. 6 is a perspective view showing an interior of a main body of the automatic alternative content search apparatus for the visually impaired person according to the embodiment of the present invention.

FIG. 7 is a perspective view showing the interior of the main body of FIG. 6 before operation.

FIG. 8 is a perspective view showing the interior of the main body FIG. 6 after operation.

FIG. 9 is a partial front view showing movement of a lower fixing device of FIG. 6 according to operation thereof.

### DESCRIPTION OF THE REFERENCE NUMERALS IN THE DRAWINGS

1: automatic search apparatus
H: storage recess
2: main body
3: support part
4: first support portion
5: second support portion
6: head part
10: lower fixing device
11: lower fixing member
12: cylinder
13: cylinder fixing portion
14: fixing frame
15: moving portion
16: bearing
7: limit switch
18: limit switch detecting unit
19: rail
20: upper fixing device
21: upper fixing member
22: first fixing portion
23: second fixing portion
24: cylindrical portion
25: support portion
30: motor
31: gear
32: motor fixing member

### BEST MODE

Reference will now be made in detail to various embodiments of the present invention, specific examples of which are illustrated in the accompanying drawings and described below, since the embodiments of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims.

It will be understood that when an element is referred to as being “coupled” or “connected” to another element, it can be directly coupled or connected to the other element or intervening elements may be present therebetween.

In contrast, it should be understood that when an element is referred to as being “directly coupled” or “directly connected” to another element, there are no intervening elements present.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the present invention is described in detail with reference to the accompanying drawings. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention. Further, if not stated, the technologic and scientific terms used herein have the meanings generally understood by those skilled in the art, and functions and configurations known in the art that may make the subject matter of the present invention unclear are not described and shown in the drawings. However, the drawings are provided as example for those skilled in the art to be able to more clearly understand the spirit of the present invention. Accordingly, the present invention is not limited to the drawings and may be achieved in other ways. Further, like reference numerals are given to like components throughout the specification. It should be noted that the same components are given the same reference numerals in any drawings.

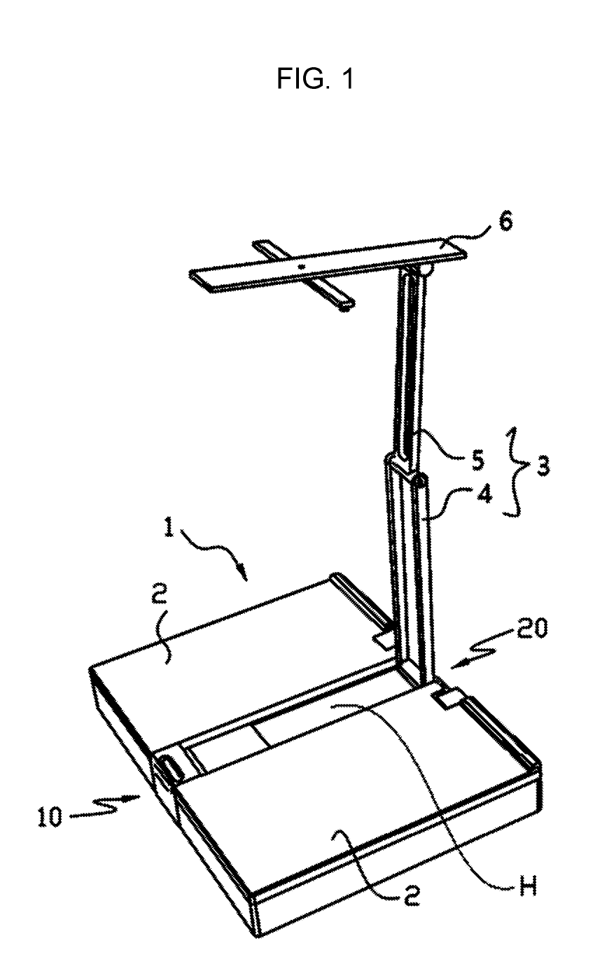

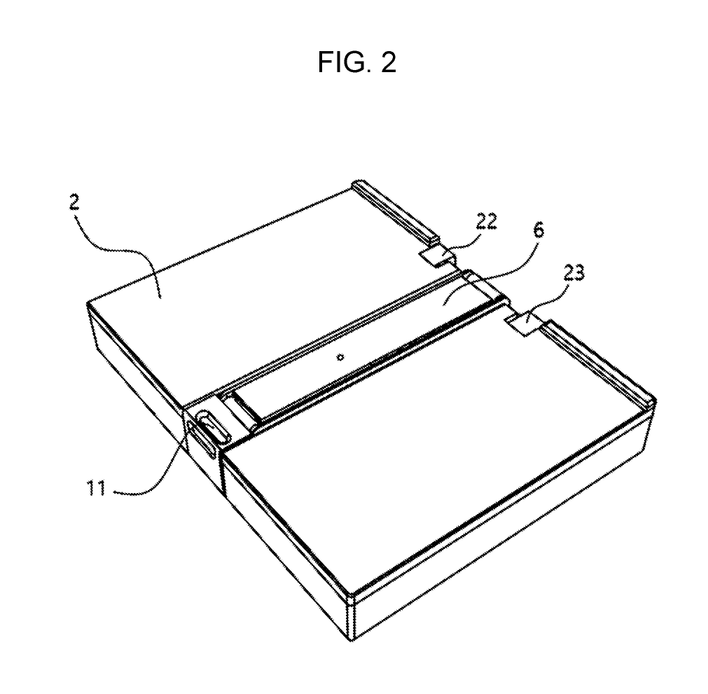

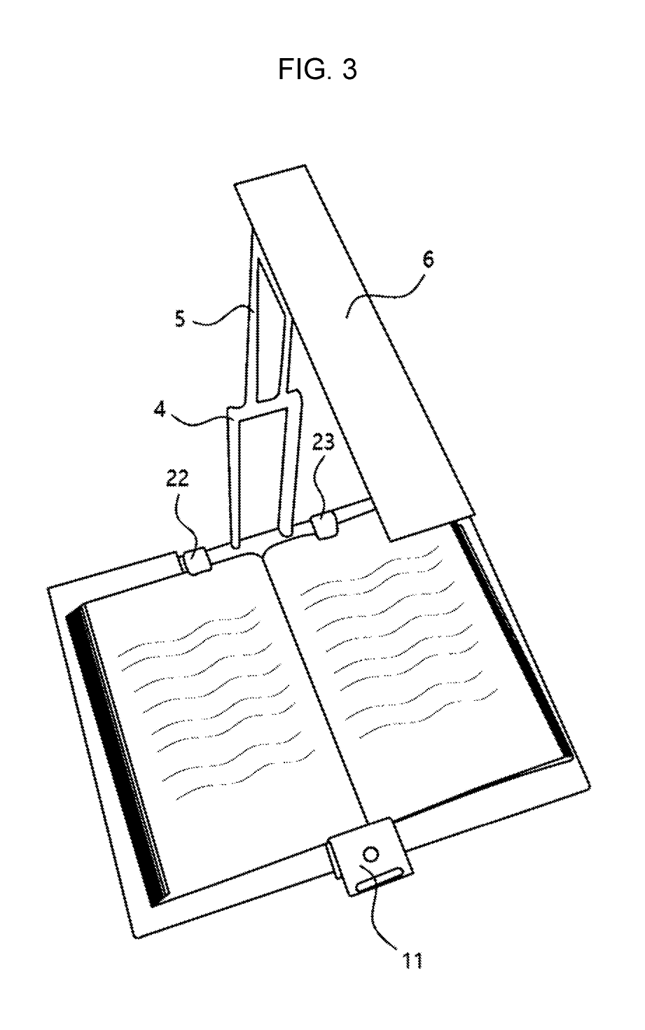

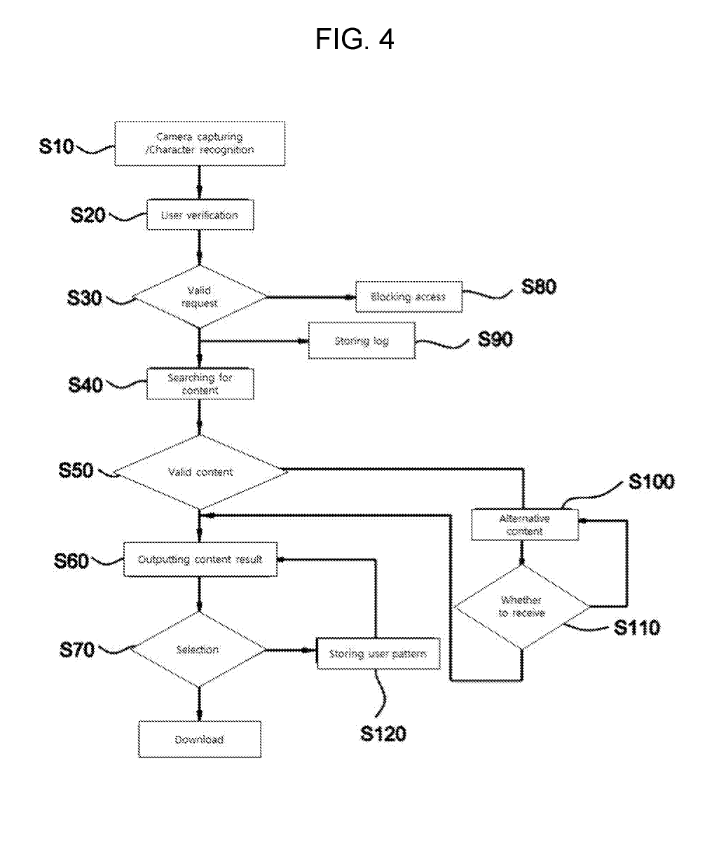

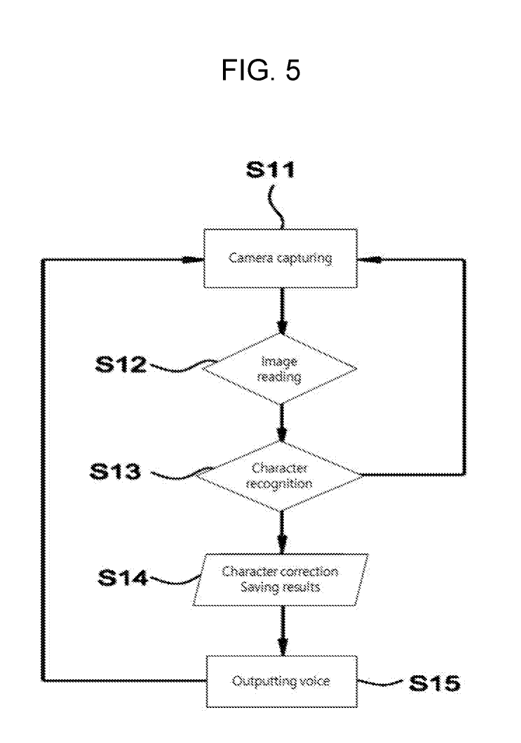

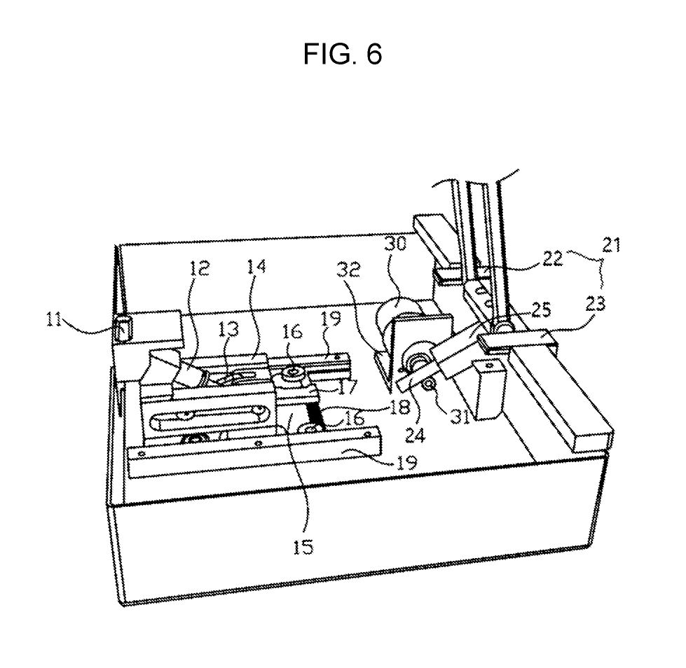

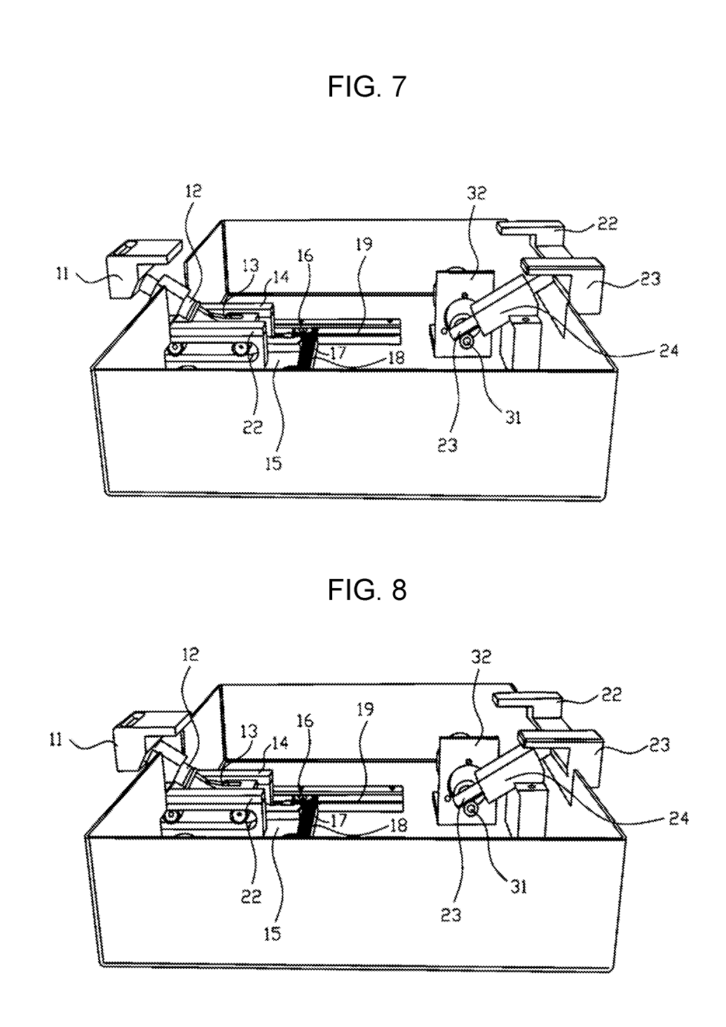

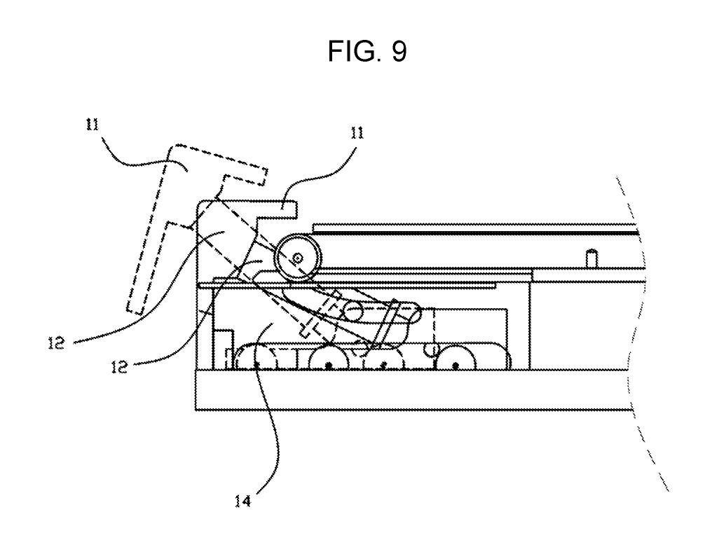

FIG. 1 is a perspective view showing an automatic alternative content search apparatus for a visually impaired person according to an embodiment of the present invention, FIG. 2 is a perspective view showing a state where a support part and a head part of the automatic alternative content search apparatus for the visually impaired person according to the embodiment of the present invention are folded, FIG. 3 is a perspective view showing a state where a book is fixed to the automatic alternative content search apparatus for the visually impaired person according to the embodiment of the present invention, FIG. 4 is a flowchart showing steps of receiving textbook content using the automatic alternative content search apparatus for the visually impaired person according to the embodiment of the present invention, FIG. 5 is a flowchart showing steps of outputting recognized characters as voice by the automatic alternative content search apparatus for the visually impaired person according to the embodiment of the present invention, FIG. 6 is a perspective view showing an interior of a main body of the automatic alternative content search apparatus for the visually impaired person according to the embodiment of the present invention, FIG. 7 is a perspective view showing the interior of the main body of FIG. 6 before operation, FIG. 8 is a perspective view showing the interior of the main body FIG. 6 after operation, and FIG. 9 is a partial front view showing movement of a lower fixing device of FIG. 6 according to operation thereof.

Hereinafter, preferred embodiments of an automatic search apparatus for a visually impaired user according to the present invention will be described in detail with reference to the accompanying drawings. Embodiments of the present invention are presented to make complete disclosure of the present invention and help those who are ordinarily skilled in the art best understand the invention. Various changes to the following embodiments are possible and the scope of the present invention is not limited to the following embodiments.

FIG. 1 is a perspective view showing the automatic alternative content search apparatus for a visually impaired person according to the embodiment of the present invention.

As shown in FIG. 1, the automatic search apparatus 1 includes a main body 2 on which a book or a document is placed, a support part 3 vertically provided at a central portion of a first end of the main body 2, a head part 6 coupled to an end of the support part 3, a lower fixing device 10 provided at a central portion of a second end of the main body 2, and an upper fixing device 20 provided at the central portion of the first end of the main body 2.

The main body 2 is formed in a rectangular box shape such that a book or a document is easily placed thereon. The main body 2 is provided with a storage recess H formed at a center of the main body in the lengthwise direction thereof such that the support part 3 and the head part 6 are folded and stored therein.

The upper fixing device 20 is symmetrically provided with respect to the support part 3 such that a book or a document placed on the main body 2 is easily fixed on the main body 2 by the lower fixing device 10 and the upper fixing device 20.

The support part 3 is configured such that a first support portion 4 and a second support portion 5 are hinged to each other and the first support portion 4 and the second support portion 5 are folded together, whereby the support part is adjustable in angle. Further, an end of the second support portion 5 and the head part 6 are hinged to each other such that the head part 6 is adjustable in angle.

The head part 6 is provided with a camera (not shown) for capturing a book or a document and a light lamp (not shown) provided for accurate reading of the book or the document placed on the main body 2, such that images of the book or the document placed on the main body 2 are clearly captured by the camera.

The camera may be configured to recognize two A4 size documents at the same time by applying a dual camera installed at both sides of the head part, such that two pages of a book are recognized at the same time. In addition, the camera may be configured to capture and read consecutive pages in advance during the time period that characters recognized by the camera are output as voice by supporting consecutive capturing, thereby reading the book without interruption of the pages and thus reducing the reading time.

Moreover, the camera may be configured to efficiently recognize characters of a book having various shapes by applying a camera module supporting a minimum font size of 2 mm, such that the characters of the book are accurately recognized by the camera.

The main body 2 is provided with a voice output unit for outputting images and characters captured by the camera as voice, and may be further provided with a braille output unit (not shown) for outputting the characters recognized by the camera as braille characters.

The voice output unit may include a built-in speaker (not shown) for outputting voice and an earphone output unit (not shown) for allowing a user to listen to the voice with earphones.

The main body 2 may be further provided with an SD memory card insertion unit (not shown) and a USB port (not shown) such that a SD memory card can be used for memory expansion and a user can work using a USB device.

In addition, the main body 2 is provided with a recognition processing unit (not shown) for recognizing as characters images captured by the camera and read, and may be further provided with a control unit (not shown) for correcting the recognized characters by the recognition processing unit and storing a corrected result.

The recognition processing unit may include an image processing unit for processing image data of a book or a document captured by the camera, an image recognition unit for recognizing a character portion extracted from the image processing unit, a text file conversion unit for converting character data recognized by the image recognition unit into a text file, and a voice signal generation unit for converting the text file into a voice signal and outputting the voice signal.

Further, the main body 2 is provided with a data output unit (not shown) for determining the purpose of character recognition of a document such as a bill or a business card placed on the main body 2 and providing data corresponding thereto. For example, when the electricity bill is placed on the main body 2, the electricity bill amount is output as data, or when the business card is placed on the main body, information such as a name of company, a name, a title, and a telephone number in the business card is provided to a user.

FIG. 2 is a perspective view showing the state where the support part 3 and the head part 6 of the automatic alternative content search apparatus 1 according to the present invention are folded.

As shown in FIG. 2, the support part 3 and the head part 6 are folded and inserted into the storage recess H formed on the main body 2. As described above, the first support portion 4 and the second support portion 5 of the support part 3 are foldable together, and the second support portion 5 and the head part 6 are foldable, whereby the support part 3 and the head part 6 can be easily adjusted in angle and can be easily stored in the storage recess H of the main body 2 and thus the automatic alternative content search apparatus 1 can be easily stored and carried.

FIG. 3 is a perspective view showing the state where a book is fixed to the automatic search apparatus according to the present invention.

As shown in FIG. 3, when a book or a document is placed on the main body 2, a lower fixing member 11 of the lower fixing device 10 and a first fixing portion 22 and a second fixing portion 23 of the upper fixing device 20 fix respective ends of the book whereby the book is stably fixed. Thereafter, the pages of the book are captured using the camera provided at the head part 6 and the images and characters of the captured pages are read and then the recognized characters are output as voice from the voice output unit.

The automatic search apparatus 1 is configured such that functions such as recognition, start, stop, voice output speed control, bookmark, page search, list search and the like are controlled by a portable controller (not shown) whereby it can be operated at any time during movement, and may be configured to more easily control the functions by applying touch buttons.

FIG. 4 is a flowchart showing the steps of receiving textbook content using the automatic search apparatus according to the present invention.

The automatic search apparatus according to the present invention is configured to automatically search for book content or the alternative content in a content server and download selected content after capturing a book cover and recognizing the captured book cover as characters, thereby improving accuracy and accessibility, which will be described below with reference to FIG. 4.

When a book cover is captured by the camera provided at the automatic search apparatus 1 and a captured image is recognized as characters (S10), a step of verifying a user (S20) is performed. The step of verifying a user (S20) may be performed using a unique identification number registered in the automatic search apparatus or software. After the step of verifying a user (S20), a step of determining whether user verification is a valid request (S30) is performed. When the user verification is determined to be the valid request, a step of searching for content (S40) is performed and content required by a user is searched. When the user verification is not the valid request, access is blocked (S80) such that content search is stopped.

When the user verification is determined to be the valid request and the step of searching for the content (S40) is performed, log data (S90) is stored in a server such that user's information is stored in the server.

After the step of searching for the content (S40), a step of verifying whether the searched content is valid content (S50) is performed. When the searched content is the valid content, a step of outputting a content result (S60) is performed. When the searched content is not the valid content, a step of searching for alternative content in the server (S100) is performed and the alternative content is provided.

After the alternative content is provided to a user, a step of determining whether to receive the alternative content (S110) is performed. When the user receives the alternative content, the step of outputting the content result (S60) is performed. When the user does not receive the alternative content, the step of searching for the alternative content (S100) is performed again and another alternative content is provided to the user.

After the step of outputting the content result (S60), a step of selection by a user (S70) is performed and then a user can download and use the selected content.

Herein, when a user selects the content, a content selection pattern of the user is stored (S120).

FIG. 5 is a flowchart showing steps of outputting recognized characters as voice by the automatic alternative content search apparatus for a visually impaired person according to the embodiment of the present invention.

Referring to FIG. 5, a book or a document placed on the main body 2 is captured by the camera (S11), a captured image is read (S12), and the read image is recognized as characters by the recognition processing unit (S13).

When the read image is not recognized as characters, the capturing by the camera is repeatedly performed (S11) until the captured image is recognized as characters, such that the captured image is recognized as characters.

When the image captured by the camera is recognized as characters by recognition processing unit, the recognized characters are corrected and the corrected result is stored by the control unit (S14). Then, the recognized characters are output as voice by the voice output unit (S15).

While the voice is reproduced by the voice output unit, the capturing by the camera is consecutively performed such that the following image is read and character recognition is consecutively performed.

Although the preferred embodiment of the automatic alternative content search apparatus for a visually impaired person according to the present invention has been disclosed for illustrative purposes, those skilled in the art will appreciate that various modifications, additions and substitutions are possible, without departing from the scope and spirit of the invention as disclosed in the accompanying claims.

FIG. 6 is a perspective view showing the interior of the main body according to the present invention.

As shown in FIG. 6, the lower fixing device 10 includes a lower fixing member 11 for fixing a book or a document, a cylinder 12 provided at a lower end of the lower fixing member 11, a cylinder fixing portion 13 for fixing the cylinder 12, a fixing frame 14 provided at each of opposite sides of the cylinder fixing portion 13 and surrounding the cylinder fixing portion 13, a moving portion 15 provided at a lower end of the fixed frame 14, with bearings 16 mounted thereon, and a limit switch detecting unit 18 provided at an end of the moving portion 15. The upper fixing device 20 includes an upper fixing member 21 including a first fixing portion 22 and a second fixing portion 23, a cylindrical portion 24 provided at a lower end of the upper fixing member 21, and a support portion 25 provided at an outside of the cylindrical portion 24.

Further, the lower fixing device 10 is configured such that rails 19 guiding a movement path of the bearings 16 of the moving portion 15 are provided in the main body 2, whereby the lower fixing device 10 moves along the rails 19.

The lower fixing device 10 serves to fix a lower side of a book or a document placed on the main body 2, and is configured to be adjusted in position according to the thickness of the book or the document, which will be described below with reference to FIGS. 7 and 8.

Meanwhile, the upper fixing device 20 is provided at a rear surface of the main body 2 correspondingly to the lower fixing device 10 so as to fix an upper side of a book or a document.

The upper fixing device 20 includes the upper fixing member 21 including the first fixing portion 22 and the second fixing portion 23 so as to fix both pages of a book, the cylindrical portion 24 having a gear groove is provided at the lower end of the upper fixing member 21, and the support portion 25 is provided at the outside of the cylindrical portion 24.

The cylindrical portion 24 has the gear groove formed on a lower end surface thereof in the lengthwise direction thereof such that the upper fixing device 20 is moved vertically upon rotation of a motor 30 mounted in the main body 2.

The motor 30 is fixed in the main body 2 by a motor fixing member 32 and is provided at an end thereof with a gear 31 such that the cylindrical portion 24 is moved in conjunction with rotation of the gear 31.

Although not shown in the drawings, the main body 2 may be provided with a PCB substrate such that the upper fixing device 20 is moved in cooperation with movement of the lower fixing device 10.

In other words, the PCB substrate is provided with a sensor unit (not shown) for sensing the movement of the lower fixing device 10 such that the upper fixing device 20 is moved in cooperation with the movement of the lower fixing device 10. Accordingly, by only operation of the lower fixing device 10, the upper fixing device 20 is moved together therewith and the automatic search apparatus 1 is powered on by the operation of the lower fixing device 10.

The lower fixing device 10 may be operated by a user's operation applying pressure on the lower fixing member 11 by hand. For example, when the lower fixing device 10 is pulled upward, the lower fixing device 10 is moved upward, and when the lower fixing device 10 is pressed downward, the lower fixing device 10 is moved downward.

Herein, the lower fixing device 10 is provided with a pressure sensor (not shown) for recognizing a signal of pressure applied firstly by a user such that the lower fixing device 10 is operated by the user in a semi-automatic manner.

In other words, when pressure is applied to the lower fixing member 11 of the lower fixing device 10 upward or downward, the lower fixing member 11 is moved upward or downward. When the lower fixing member 11 is caught by a book placed on the main body 2 and applied with pressure due to the book, the movement of the lower fixing device 10 is stopped.

Further, the limit switch detecting unit 18 provided at the lower fixing device 10 senses movement of a limit switch 17 and transmits the sensed movement to the motor 30, such that the upper fixing device 20 is moved in cooperation with the movement of the lower fixing device 10.

Hereinafter, the embodiment of the automatic search apparatus according to the present invention will be described with reference to FIG. 7 to FIG. 9.

FIG. 7 is a perspective view showing the interior of the main body 2 of the automatic search apparatus, that is, the state before the automatic search apparatus is operated, FIG. 8 is a perspective view showing the state after the automatic search apparatus is operated, and FIG. 9 is a partial front view showing the movement of the lower fixing device 10 of FIGS. 7 and 8.

As shown in FIGS. 7 and 9, the lower fixing device 10 and the upper fixing device 20 are positioned inside the main body 2 before they are operated.

The lower fixing device 10 may be positioned at rear sides of the rails 19 before it is operated such that the lower fixing member 11 is placed on the main body 2. The upper fixing device 20 may also be placed on the main body 2 such that the upper fixing member 21 does not protrude from the main body 2.

As described above, the lower fixing device 10 is operated when the lower fixing member 11 is applied with pressure. Thus, when the lower fixing member 11 is pulled upward, the lower fixing member 11 is moved upward.

When the lower fixing member 11 is moved upward, the lower fixing device 10 positioned at the rear sides of the rails 19 is moved to front sides of the rails 19, and the lower fixing member 11 is moved upward or downward due to pressure of the cylinder 12 provided at the lower end of the lower fixing member 11.

Further, when the lower fixing device 10 is moved, the movement of the lower fixing device 10 is transmitted to the PCB substrate by the limit switch 17 and the limit switch detecting unit 18 provided at the lower fixing device 10. Thereafter, the motor 30 is rotated by the sensor unit mounted on the PCB substrate whereby the upper fixing device 20 is moved upward by a distance that the position of the lower fixing device 10 is changed.

The cylinder 12 provided at the lower fixing device 10 may include a motor such that the lower fixing device is moved vertically.

The lower fixing device 10 is determined in forward or backward movement distance by the length of the rails 19. Accordingly, the rails 19 may be increased in length and thus the lower fixing device 10 may be increased in movement distance, thereby facilitating fixing of books or documents having various sizes.

In other words, when the size of a book or a document is small, the lower fixing device 10 is positioned at the rear sides of the rails 19, whereas when the size of the book and the document is large, the lower fixing device 10 is positioned at the front sides of the rails 19. Thus, books or documents having various sizes can be easily fixed.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An automatic alternative content search apparatus for a visually impaired person, the apparatus comprising:
a main body (2) on which a book or a document is placed;
a support part (3) vertically provided at a center of a first end of the main body (2) and configured such that a first support portion (4) and a second support portion (5) are folded together;
a head part (6) provided at an end of the support part (3) and provided with a camera and a light lamp;
a recognition processing unit including an image recognition unit recognizing an image captured by the camera and a character recognition unit recognizing the image read by the image recognition unit as characters;
a voice output unit outputting the characters recognized by the recognition processing unit as voice; and
lower and upper fixing devices (10 and 20) fixing the book or the document placed on the main body (2).

2. The apparatus of claim 1, wherein the head part (6) and the support part (3) are folded and stored in a storage recess (H) formed at a center of the main body (2) in the lengthwise direction thereof.

3. The apparatus of claim 1, wherein the camera is configured to capture and recognize two pages at the same time by applying a dual camera.

4. The apparatus of claim 1, wherein the apparatus is configured to search for book content or the alternative content in a content server and download selected content after capturing a book cover and recognizing the captured book cover as the characters.

5. The apparatus of claim 1, wherein the main body (2) is provided with a data output unit for determining a purpose of character recognition of the document placed on the main body and providing data corresponding thereto.

6. The apparatus of claim 1, wherein the lower fixing device (10) includes:
a lower fixing member (11) fixing the book or the document;
a cylinder (12) provided at a lower end of the lower fixing member (11);
a cylinder fixing portion (13) fixing the cylinder (12);
a fixing frame (14) provided at each of opposite sides of the cylinder fixing portion (13) and surrounding the cylinder fixing portion (13);
a moving portion (15) provided at a lower end of the fixing frame (14) and provided with bearings (16) mounted thereon; and
a limit switch detecting unit (18) provided at an end of the moving portion (15), and
wherein the upper fixing device (20) includes:
an upper fixing member (21) including a first fixing portion (22) and a second fixing portion (23);
a cylindrical portion (24) provided at a lower end of the upper fixing member (21); and
a support portion (25) provided at an outside of the cylindrical portion.

7. The apparatus of claim 6, wherein the lower fixing device (10) is configured to move along rails (19) provided in the main body (2).

8. The apparatus of claim 6, wherein the limit switch detecting unit (18) of the lower fixing device (10) is electrically connected with a motor (30) such that the upper fixing device (20) is moved in cooperation with movement of the lower fixing device (10).

9. The apparatus of claim 6, wherein the lower fixing device is provided with a pressure sensor such that the lower fixing device is operated when pressure is firstly applied thereto, and is stopped when the lower fixing device is caught by the book and applied with pressure due to the book.
